(19) United States
(12) Patent Application Publication
(10) Pub. No.: US 2011/0125558 A1
(43) Pub. Date: May 26, 2011

(54) METHOD AND DEVICE FOR GENERATING TOLL INFORMATION IN A ROAD-TOLL SYSTEM

(75) Inventors: Peter Van Haperen, Burgstetten (DE); Jan Kersten, Oppenweiler (DE); Jasja Tijink, Perchtoldsdorf (AT)

(73) Assignee: KAPSCH TRAFFICCOM AG, Wien (AT)

(21) Appl. No.: 12/900,928

(22) Filed: Oct. 8, 2010

(30) Foreign Application Priority Data
Nov. 23, 2009 (EP) 09450219.2

(51) Int. Cl. G07B 15/00

(52) U.S. Cl. 705/13

(57) ABSTRACT

A method for generating toll information for vehicle devices in a road-toll system with a toll center and geographically distributed radio beacons. The method includes providing a set of location data of toll-requiring geo-objects from the respective local environment of a beacon in this beacon, recording a sequence of position data of a vehicle device in this vehicle device, if the aforementioned vehicle device is in the transmitting/receiving range of a beacon: receiving the location-data set from this beacon in the vehicle device, comparing the position-data sequence with the received location-data set in the vehicle device in order to generate toll information therefrom, and if the above-mentioned vehicle device is in the transmitting/receiving range of a beacon: transmitting the toll information from the vehicle device via the beacon to the toll center. The invention further relates to a vehicle device, a beacon and a monitoring device for such a road-toll system.

### CROSS-REFERENCE TO RELATED APPLICATION(S)

This application claims priority to European Patent Application No. 09 450 219.2, filed on Nov. 23, 2009, the contents of which are hereby expressly incorporated by reference.

### FIELD OF THE INVENTION

The present invention relates to a method for generating toll information from the movements of vehicle devices in a road-toll system that comprises at least one toll center and a plurality of connected geographically distributed beacons for short-range radio communication with the vehicle devices.

The invention further relates to a vehicle device (onboard unit, OBU) for such a road-toll system with a satellite-navigation receiver for generating a sequence of position data, a first memory for recording the position-data sequence, as well as a short-range transceiver for radio communication with one of many geographically distributed beacons when the vehicle device is located in the transmitting/receiving range of these beacons.

Finally, the invention also relates to a beacon and to a monitoring device for such a road-toll system.

### BACKGROUND

“Short-range” radio communication is understood in the present description to mean radio distances (cell radii) of up to several kilometers

In their functions, role distributions and interfaces, modern road-toll systems follow the principles defined in ISO Standard 17573, “Road Transport and Traffic Telematics—Electronic Fee Collection—System Architecture for Vehicle Related Transport Services.” According to the latter there are essentially two basic types of systems.

“infrastructure-bound” systems, e.g., DSRC (dedicated short-range communication) toll systems, in which roadside infrastructure (roadside equipment, RSE), e.g., DSRC radio beacons, locates and charges tolls to the OBUs; and

“infrastructure-less” systems such as GNSS (global navigation satellite systems) toll systems, in which the OBUs autonomously locate themselves and transmit either “raw” position data (as so-called “thin clients”), or “finished” toll information calculated from the position data and toll maps (as so-called “thick clients”) to the toll center via a mobile-radio network (cellular network, CN).

Infrastructure-bound toll systems achieve a high degree of toll-charging security, but require extensive roadside infrastructure for this, in order to be able to locate OBUs over a large area, because the positional resolution of the location-finding is given from the size of the transmitting/receiving ranges and the number of beacons. Infrastructure-less toll systems, on the other hand, have basically unlimited coverage due to the self-locating-finding ability of the OBUs, but require enormous computational power (server farm) in the toll center for “thin client” systems in order to generate toll information from the raw position data of the OBUs, or in the case of “thick client systems,” require correspondingly expensive OBUs which can record and process all the toll maps of the toll coverage area, and this also presumes a correspondingly expensive distribution and updating of the toll maps via the mobile-radio network. This data traffic consumes bandwidth and, not least important, is expensive for the user.

### SUMMARY

The invention is directed to methods and devices for a road-toll system that combine the advantages of the known systems without adopting their respective disadvantages.

In a first aspect of the invention, a method of the type mentioned above includes the steps:

providing a set of location data of toll-requiring geo-objects from the respective local environment of a beacon in this beacon,

recording a sequence of position data of a vehicle device in this vehicle device,

if the aforementioned vehicle device is in the transmitting/receiving range of a beacon: receiving the location-data set from this beacon in the vehicle device,

comparing the position-data sequence with the received location-data set in the vehicle device in order to generate toll information therefrom, and

if the above-mentioned vehicle device is in the transmitting/receiving range of a beacon: transmitting the toll information from the vehicle device via the beacon to the toll center.

In a second aspect, the invention is a vehicle device of the type mentioned above that is distinguished by a second memory for holding at least one set of location data of toll-requiring geo-objects from the environment of a beacon, which location-data set is received by means of the short-range transceiver from this beacon, wherein the vehicle device compares the recorded position-data sequence with the received location-data set or sets in order to generate toll information therefrom, and transmits this toll information via the short-range transceiver to a beacon when the vehicle device is in its transmitting/receiving range.

In a third aspect of the invention, a beacon for such a road-toll system includes a short-range transceiver for radio communication with vehicle devices that are located in its transmitting/receiving range and is characterized by a memory for holding a set of location data of toll-requiring geo-objects from the environment of the beacon, with this beacon transmitting this location-data set to vehicle devices in its transmitting/receiving range.

In a fourth aspect, the invention is a monitoring device for a road-toll system with at least one such beacon, which device is constructed to detect movements of vehicle devices and which, based on the location-data set of a beacon and the detected movements of vehicle devices in the local environment of the beacon, checks the toll information generated by these vehicle devices—either directly in these vehicle devices or in a beacon. Incorrect or missing toll information can be recognized in this manner. In case of a negative checking result, further measures can preferably be initiated, in particular, photographic or video recording of the vehicle and/or recording and storage of data from the vehicle device.

### BRIEF DESCRIPTION OF THE DRAWINGS

The invention will be described below in detail with reference to an embodiment illustrated in the appended drawings. In the drawings:

FIG. 1 shows a partial and schematic plan view of a road-toll system that operates according to some embodiments of the invention and comprises vehicle devices and beacons according to some embodiments of the invention;

FIG. 2 shows a block schematic of a vehicle device according to some embodiments of the invention; and

FIG. 3 shows a sequence diagram of a method, according to some embodiments of the invention.

### DETAILED DESCRIPTION

The present invention is based on a novel use of self-location-finding OBUs within an infrastructure-bound toll system with radio beacons for distributing locally limited toll maps of the environment, so-called location-data sets, to passing OBUs and for receiving toll information calculated in the OBUs based on these local maps. Thereby the following advantages are achieved:

By subdividing the entire coverage area of the toll system into individual local sub-maps (location-data sets) the maintenance and provision of location data of the toll-requiring geo-objects to the OBUs is considerably simplified. In case of local changes, only the local location-data set must be updated in the center and/or the responsible beacons.

OBUs of the invention are constructed substantially more simply and economically in comparison with known “thick client” OBUs, since they only require small memories for holding the local toll maps of the area where they are located.

The data traffic necessary for distributing and updating the toll maps is also substantially reduced, which saves bandwidth. In addition, a mobile-radio network is not required for this, which saves the user considerable mobile-radio fees.

Finally the road infrastructure is also considerably simpler than for known infrastructure-bound systems: since the OBUs locate themselves, the location-finding precision is no longer dependent on the positions and density of the beacons, so that substantially fewer beacons are necessary. The beacons no longer need to have a directional characteristic—as in known DSRC systems—in order to locate passing OBUs as precisely as possible, but can instead be equipped with omnidirectional characteristics and can even service OBUs a considerable distance away, e.g., 1-2 km.

Not least of all, a beacon can thus be responsible not just for one, but for several toll-requiring geo-objects in its environs, whereby a very small number of beacons can be sufficient.

In some embodiments, the above-mentioned local environment of a beacon is larger than its transmitting/receiving range and provides the location-data set of an adjacent beacon in this beacon. Also, the location-data set of the adjacent beacon is received and compared with the position-data sequence. In this manner, the OBUs obtain current location-data sets along their route for the area in which they are located whenever they come into the transmitting/receiving range of a beacon, can process the most recently recorded position-data sequence based on these location-data sets into toll information and deliver the toll information generated in this way to a beacon along their route.

For the basic functions of the system according to the invention, it is sufficient if the OBUs are located in any manner known in the technology, for example, by means of radio direction finding in a mobile-radio network. In some embodiments, the position data is acquired and recorded with a satellite-navigation receiver of the vehicle device, as has been proven in practice for “thick client” OBUs for GNSS/CN toll systems.

The short-range radio communication between the vehicle devices and beacons can take place according to any short-range radio standard known in the art, but preferably according to the DSRC (dedicated short-range communication), WAVE (wireless access for vehicle environments) or WLAN (wireless local area network) standard, which allows the use of existing infrastructures.

In some embodiments, the location-data set additionally contains fee information that enters into the generation of the toll information. Thereby, for example, individual toll fees for individual toll-requiring geo-objects or special OBUs or OBU settings can be specified.

The location-data set can also comprise checking mechanisms such as checksums, hash functions or the like, with which its currentness, validity and/or completeness can be verified.

The generated toll information may be location-anonymized in order to guarantee data protection.

The memories of the vehicle unit of the invention may be ring buffers which hold only the most recently recorded position-data sequence(s) or the location-data set or sets most recently received, whereby memory space is saved and the vehicle device can be constructed correspondingly more inexpensively.

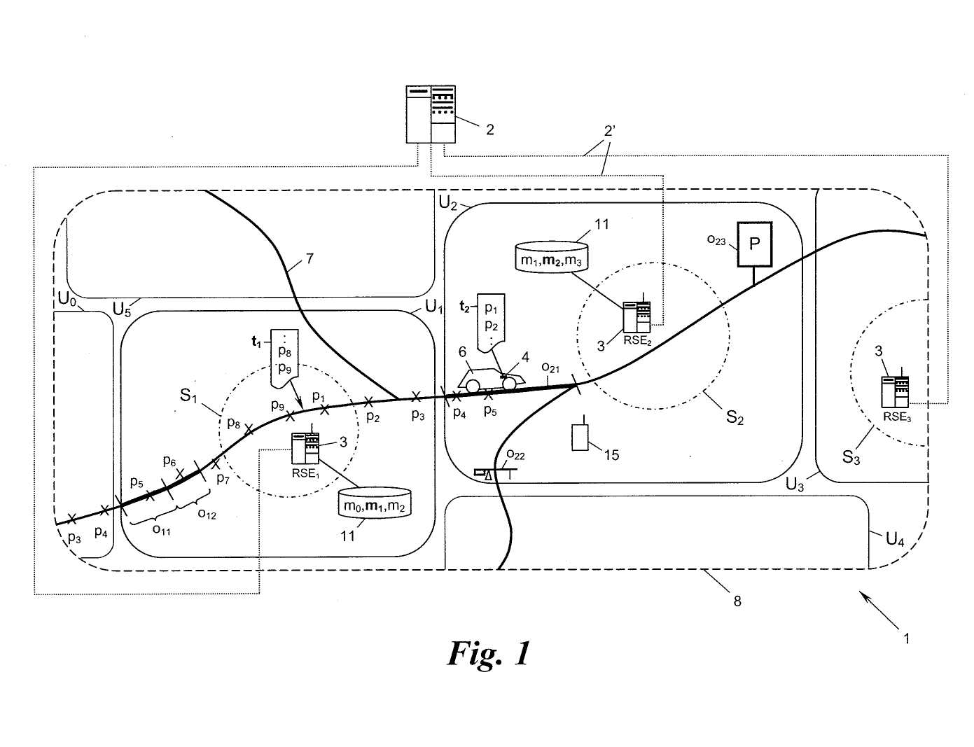

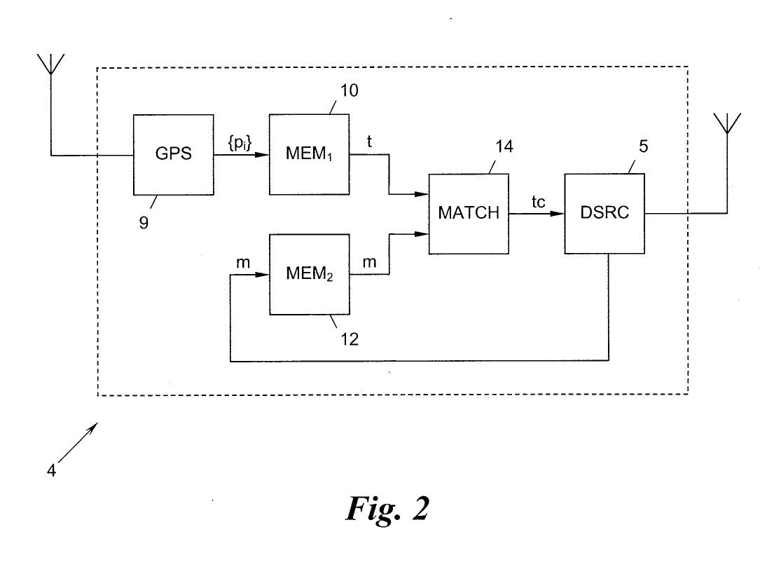

FIG. 1 shows a part of a road-toll system 1 with a toll center (central system, CS) 2 and a plurality of connected geographically distributed short-range radio beacons 3 (“beacons” for short) that are connected via connections 2′. The beacons 3, of which only three representative beacons RSE₁, RSE₂, RSE₃ (in general RSEᵢ) are shown, each have a locally limited transmitting/receiving range S₁, S₂, S₃ (Sᵢ in general), inside of which they can communicate with vehicle devices or OBUs 4. For this purpose, the OBUs 4 are equipped with corresponding short-range transceivers 5 (FIG. 2) for radio communication with the beacons 3. The short-range radio communication between the beacons 3 and the OBUs 4 preferably takes place according to the DSRC, WAVE or WLAN standard.

The OBUs 4 are carried by vehicles 6 that move on traffic areas 7, e.g., roads, freeways, parking lots, parking garages etc. of the coverage area 8 of the road-toll system 1.

The coverage area 8 of the road-toll system 1 is subdivided into a plurality of adjacent local environments U₀, U₁, U₂, U₃, U₄ (Uᵢ in general), to each of which one of the beacons 3 is assigned. The local environment Uᵢ of a beacon 3 is preferably larger than its transmitting/receiving range Sᵢ. Geographical objects oᵢⱼ, so-called toll-requiring geo-objects, in the coverage area 8 of the road-toll system 1, wherein the usage of these objects by a vehicle 6 or, more precisely, its OBU 4 is to be charged (“tolled”), are distributed accordingly to the local environments Uᵢ. Each beacon 3 is therefore responsible for charging tolls to the geo-objects oᵢⱼ in its environment Uᵢ.

The toll-requiring geo-objects oᵢⱼ can be of any type. FIG. 1 shows some examples, such as street sections o₁₁, o₁₂ and o₂₁ that require tolls for traveling on them, a parking lot o₂₃ whose usage is subject to a fee and a barrier o₂₂ that requires a toll for passage.

As shown in detail in FIG. 2, each OBU 4 is equipped with a device 9 for autonomous position finding. The device 9 is preferably a satellite-navigation system, e.g., a GPS receiver, that continually determines its position in a global satellite-navigation system and generates therefrom a sequence (“track”) t of position data (“position fixes”) p₁, p₂, . . . that is recorded in a first memory 10 of the OBU 4. The memory 10 is preferably a ring buffer that only contains the most recently acquired position data pᵢ.

Referring back to FIG. 1, each beacon 3 provides the location data of the geo-objects oᵢⱼ in its environment Uᵢ as a location-data set mᵢ in a local memory 11 for passing OBUs 4. The location-data set mᵢ is managed locally in the beacon 3 or is distributed centrally from the toll center 2 to the beacons 3 via the connections 2′. Each beacon 3 preferably also contains, in addition to its own location-data set mᵢ, the location-data sets of one or more adjacent environments Uᵢ, in this case, for example, the location-data sets m₁ and m₃ of the adjacent environments U₁ and U₃ for the beacon RSE₂.

If an OBU 4 enters the transmitting/receiving range Sᵢ of a beacon 3, the beacon 3 transmits the location-data sets mᵢ provided in its memory 11 to the OBU 4, which receives them via its transceiver 5 and stores them in a second memory 12. The second memory 12 is also preferably a ring buffer, which holds only the most recently received location-data sets mᵢ.

The OBU 4 then compares the position-data sequence t recorded in the memory 10 with the received location-data sets mᵢ in the memory 12 for geographical similarity or association (“map matching,” block 14), in order to generate toll information tc (“toll charges”) therefrom.

The toll information tc generated in the OBU 4 is dispatched via the transceiver 5 to a beacon 3, specifically, either to the same beacon 3, if the OBU 4 is still in its transmitting/receiving range Sᵢ. or to a subsequent beacon 3 whose transmitting/receiving range Sᵢ the OBU 4 enters on its way.

Fee information, such as geo-object-specific or OBU-specific or OBU-setting-specific toll fees, that was received from the beacons 3 together with the location-data sets mᵢ is preferably also taken into account in the “map-matching” comparison 14.

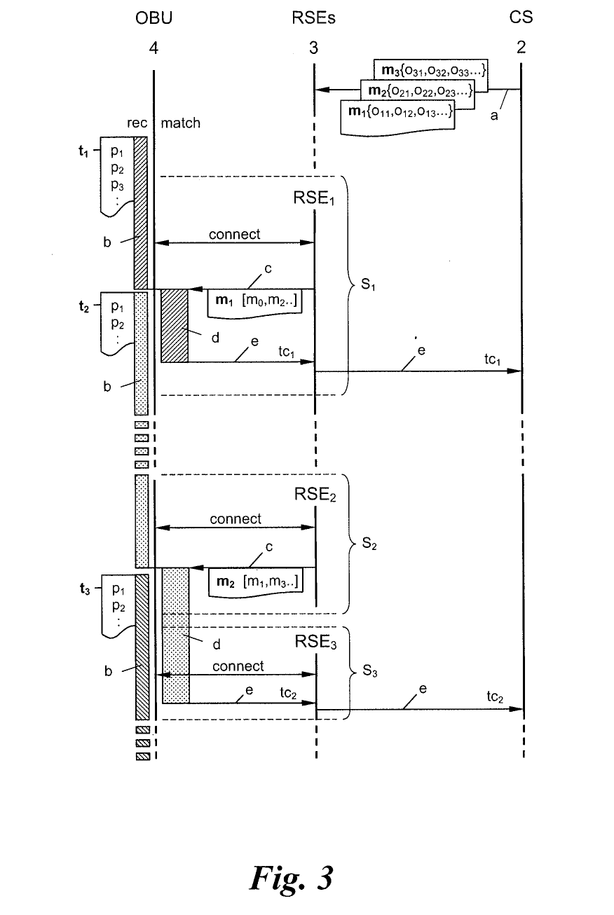

FIG. 3 shows a sequence of the process once again in detail according to some embodiments of the invention. In a first step a), one or more sets mᵢ with location data of toll-requiring geo-objects oᵢⱼ of the respective environment Uᵢ of a beacon 3 are provided in the beacons 3, for example, by reception from the toll center 2 via the connections 2′.

In a step b), an OBU 4 records a first sequence t₁ of position data {p₁, p₂, p₃, . . . } in its memory 10. In a step c), as soon as the OBU 4 reaches the transmitting/receiving range S₁ of a first beacon 3, here RSE₁, it receives from the latter, after an appropriate handshake (“connect”), the location-data set m₁ of the beacon RSE₁ and optionally the location-data sets m₀, m₂ of the associated environments U₀, U₂.

In a subsequent step d), the OBU 4 performs a comparison between the recorded position-data sequence t₁ and the received location-data set or sets m₀, m₁, m₂ (“map matching”—block 14), optionally taking into account geo-object-specific and or OBU (setting)-specific fee information, which was received together with the location-data sets mᵢ, and generates toll information tc₁ therefrom. The toll information tc₁ is dispatched in a subsequent step e) via the transceiver 5 of the OBU 4, and via the closest available beacon 3, here still the beacon RSE₁, to the toll center 2.

After generation of the first toll information tc₁, the ring buffer 10 can be erased and it is possible to start again with the recording of the position data pᵢ in order to record the next position-data sequence t₂{p₁, p₂, . . . }.

As soon as the OBU 4 then reaches the transmitting/receiving range S₂ of a next beacon 3, here RSE₂, on its route, the steps c) and d) are performed again. As shown in FIG. 3, the generated second toll information tc₂ can be dispatched to the toll center 2 via one of the next beacons 3 on the route, here the beacon RSE₃, e.g., if the transmitting/receiving range S₂ of the second beacon RSE₂ has already been passed through during the step d).

The location-data sets mᵢ of the beacons 3 can also be provided to (stationary or mobile) monitoring devices 15 of the road-toll system 1, preferably by direct transmission from the beacons 3 via the above-mentioned short-range radio communication The monitoring devices 15 are enabled in the conventional manner to detect or acquire the movements of vehicles 6 with vehicle devices 4 in their vicinity, for example, by means of photo or video monitoring, light barriers, radar or laser scanners, etc. The monitoring devices 15 check the toll information tcᵢ generated by the vehicle devices 4, based on the location-data set or sets mᵢ of a beacon 3 and the acquired vehicle movements in the environment Uᵢ of the beacon 3, and in the event of a divergence, e.g., a malfunction or a toll evasion, can then initiate further measures such as a photographic or video recording of the vehicle 6 and/or a registration and storage of data from the vehicle device 4.

If the toll system 1 also comprises “thin client” OBUs, which transmit their position-data sequences tᵢ directly to a beacon 3, so that the latter can generate the toll information tcᵢ based on their location-data sets mᵢ, the monitoring devices 15 could also be used to check the toll information tcᵢ generated by this beacon 3, based on the location-data sets mᵢ received by a beacon and the detected movements of the OBUs in the local environment Uᵢ of a beacon.

The invention is not limited to the illustrated embodiments, but rather comprises all variants and modifications that fall within the scope of the appended claims.

1. A method for generating toll information from movements of vehicle devices in a road-toll system that comprises at least one toll center and a plurality of connected, geographically distributed beacons for short-range radio communication with the vehicle devices, the method comprising:
providing, in a beacon, a set of location data of one or more toll-requiring geo-objects from a local environment of said beacon;
recording, in a vehicle device, a sequence of position data of said vehicle device;
when said vehicle device is in the transmitting/receiving range of said beacon, receiving the location-data set from said beacon in the vehicle device;
comparing the position-data sequence with the received location-data set in the vehicle device to generate toll information therefrom; and
when said vehicle device is in the transmitting/receiving range of a beacon, transmitting the toll information from the vehicle device via the beacon to the toll center.

2. The method according to claim 1, wherein said local environment of the beacon is larger than its transmitting/receiving range, wherein a location data set of an adjacent beacon is also provided, and wherein the data set of the adjacent position is also received and compared with the position-data sequence.

3. The method according to claim 1, wherein the position data is acquired and recorded with a satellite-navigation receiver of the vehicle device.

4. The method according to claim 1, wherein the short-range radio communication between vehicle device and the beacon takes place according to the DSRC, WAVE or WLAN standard.

5. The method according to claim 1, wherein the location-data set further includes fee information utilized for generation of the toll data.

6. The method according to claim 1, wherein the location-data set further includes checksums or hash functions to verify its currentness, validity or completeness.

7. The method according to claim 1, wherein the generated toll information is location-anonymized.

8. A vehicle device for a road toll system comprising:
a satellite-navigation receiver for generating a sequence of position data;
a first memory for storing the position-data sequence;
a short-range transceiver for radio communication with one of a plurality of geographically distributed beacons when the vehicle device is in the transmitting/receiving range of one of the said beacons; and
a second memory for holding at least one set of location data of toll-requiring geo-objects from the environment of the beacon, wherein said location-data set was received by the short-range transceiver from said beacon, wherein the vehicle device is configured to compare the recorded position-data sequence with the received location-data set or sets to generate toll information therefrom, and to transmit said toll information via the short-range transceiver to a beacon when the vehicle device is in the transmitting/receiving range of said beacon.

9. The vehicle device according to claim 8, wherein the second memory is a ring buffer, which holds only the most recently received location-data set or sets.

10. The vehicle device according to claim 8, wherein the second memory holds fee information received with the location-data sets, which is utilized by the vehicle device to generate the toll information.

11. The vehicle device according to claim 8, wherein the short-range transceiver is one or more of the group consisting of a DSRC, WAVE and WLAN transceiver.

12. A beacon for a road toll system, with a short-range transceiver for radio communication with vehicle devices that are located in its transmitting/receiving range, comprising: a memory for holding a set of location data of toll-requiring geo-objects from the environment of the beacon, wherein the beacon transmits said location-data set to vehicle devices in its transmitting/receiving range.

13. The beacon according to claim 12, wherein the memory also holds location-data sets of adjacent beacons and the beacon also transmits said location data for adjacent beacons to vehicle devices in its transmitting/receiving range.

14. The beacon according to claim 12 that is connected to a toll center of the road-toll system for receiving the location-data sets from the toll center.

15. The beacon according to claim 12, wherein the beacon relays toll information received from vehicle devices to a toll center.

16. The beacon according to claim 12, wherein the beacon calculates toll information from position-data sequences received from vehicle devices and relays the toll information to a toll center.

17. A monitoring device for a road-toll system with at least one beacon according to claim 15, wherein the monitoring device is configured to detect movements of vehicle devices, and configured to check, based on the location-data set of the beacon and the detected movements of vehicle devices in the local environment of the beacon, the toll information transmitted from these vehicle devices.

18. The monitoring device according to claim 16, wherein the monitoring device is configured to detect movements of vehicle devices, and configured to check, based on the location-data set of the beacon and the detected movements of the vehicle devices in the local environment of the beacon, the toll information of said vehicle devices generated by the beacon.

19. The monitoring device according to claim 17, wherein in case of a negative checking result, the monitoring device initiates further measures, including photographic or video recording or recording and storage of data from the vehicle device.

20. The monitoring device according to claim 18, wherein in case of a negative checking result, the monitoring device initiates further measures, including photographic or video recording, or recording and storage of data from the vehicle device.
